(19) United States
(12) Patent Application Publication
(10) Pub. No.: US 2024/0186861 A1
(43) Pub. Date: Jun. 6, 2024

(54) IN-WHEEL MOTOR UNIT

(71) Applicant: TOYOTA JIDOSHA KABUSHIKI KAISHA, Toyota-shi (JP)

(72) Inventors: Keita IMAI, Seto-shi (JP); Kiichi YOKOYAMA, Toyota-shi (JP); Hiroki MONJI, Toyota-shi (JP); Yusuke UETA, Shizuoka-ken (JP); Tatsuya SAKAI, Toyota-shi (JP)

(73) Assignee: TOYOTA JIDOSHA KABUSHIKI KAISHA, Toyota-shi (JP)

(21) Appl. No.: 18/473,633

(22) Filed: Sep. 25, 2023

(30) Foreign Application Priority Data
Dec. 6, 2022 (JP) 2022-194940

(51) Int. Cl. H02K 7/116; B60K 7/00; B60K 17/04

(52) U.S. Cl. CPC H02K 7/116; B60K 7/0007; B60K 17/043

(57) ABSTRACT

The in-wheel motor unit includes a motor case, a gear case disposed adjacent to the motor case, and a knuckle integrally formed with the gear case.

### CROSS-REFERENCE TO RELATED APPLICATION

This application claims priority to Japanese Patent Application No. 2022- 194940 filed on Dec. 6, 2022, incorporated herein by reference in its entirety. BACKGROUND

### 1. Technical Field

The present disclosure relates to an in-wheel motor unit.

### 2. Description of Related Art

An in-wheel motor unit in which a motor and a speed reducer are integrated is known (see, for example, Japanese Unexamined Patent Application Publication No. 2013-209016 (JP 2013-209016 A)). In the in-wheel motor unit, a bearing support portion that supports a motor shaft with respect to a gear case (speed reducer case) is provided. The bearing support portion is disposed laterally of a knuckle.

### SUMMARY

In the configuration of JP 2013-209016 A, since the knuckle and the gear case are separate bodies, the shaking moment of the knuckle increases. As a result, the vibration of the gear case increases. Thus, there is a concern about deterioration of alignment property of the gear, eccentricity of the motor, and the like.

The present disclosure has been made in view of the above, and an object thereof is to provide an in-wheel motor unit capable of suppressing deterioration of alignment property of a gear and eccentricity of a motor.

An in-wheel motor unit according to the present disclosure includes a motor case, a gear case disposed adjacent to the motor case, and a knuckle integrally configured with the gear case.

According to the present disclosure, it is possible to improve the alignment property of the gear and suppress the eccentricity of the motor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of an in-wheel motor unit according to a first embodiment.

### DETAILED DESCRIPTION OF EMBODIMENTS

An in-wheel motor unit according to an embodiment of the present disclosure will be described with reference to the drawings. Incidentally, the constituent elements in the following embodiments include those that can be easily replaced by a person skilled in the art or those that are substantially the same.

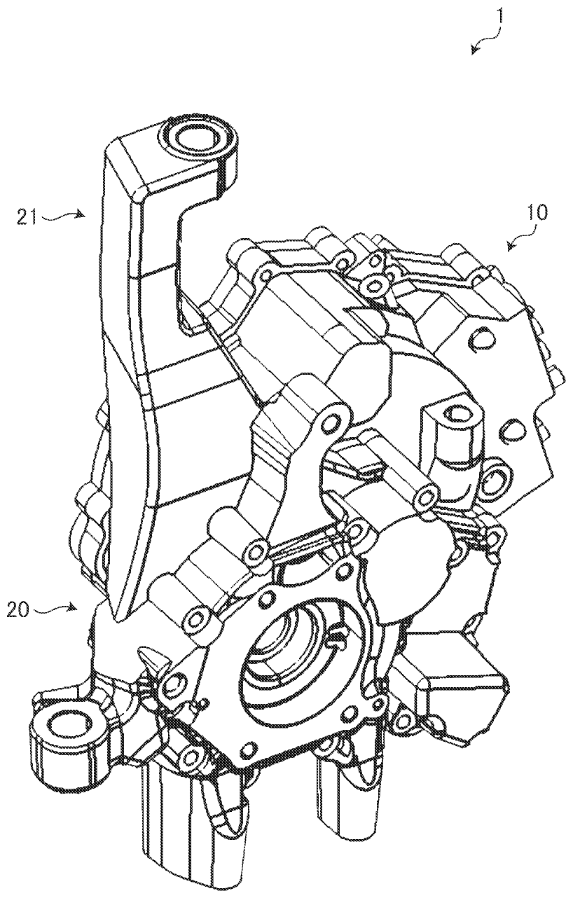

The in-wheel motor unit according to the embodiment is suspended from a vehicle body and outputs a rotational force of a built-in motor to a wheel. As shown in FIG. 1, the in-wheel motor unit 1 includes a motor case 10, a gear case 20, and a knuckle 21.

The motor case 10 is for accommodating a motor. The gear case 20 is for accommodating a speed reducer. The gear case 20 is disposed adjacent to the motor case 10. The gear case 20 is disposed on the wheel side with respect to the motor case 10. The knuckle 21 is integrally formed with the gear case 20.

Here, in JP 2013-209016 A, two places of the wheel hub and the motor case are fastened by knuckles. Further, since the motor unit is connected to the knuckle via a separate component, the number of components is large. If the wheel hub is simply fastened with a knuckle, the distance from the knuckle, which is the vehicle support portion, increases with respect to the unit of the motor and the gear, which is a heavy object. Therefore, the vibration moment due to the vibration increases, and the vibration of the gear case increases. As a result, there is a concern about deterioration of the alignment property of the gear, eccentricity of the motor, and the like.

Therefore, the motor unit needs to be fixed by a knuckle. However, only by attaching the knuckle to the motor case, the load of the vehicle is received only by the motor case which is a heavy object, and there is a possibility that the motor case is deformed.

Therefore, in the in-wheel motor unit according to the embodiment, by integrating the gear case 20 and the knuckle 21, it is possible to suppress deterioration of the alignment property of the gear due to vibration and eccentricity of the motor.

According to the in-wheel motor unit of the present embodiment described above, the gear case 20 and the knuckle 21 are integrally molded. As a result, the center of gravity of the knuckle 21 decreases and the swing moment decreases as compared with a case where the gear case 20 and the knuckle 21 are separate bodies. As a result, deterioration of the alignment property of the gear and eccentricity of the motor can be suppressed.

Further advantages and variations can be readily derived by those skilled in the art. Thus, the broader aspects of the disclosure are not limited to the specific details and representative embodiments presented and described above. Accordingly, various modifications may be made without departing from the spirit or scope of the general inventive concept as defined by the appended claims and their equivalents.

What is claimed is:

1. An in-wheel motor unit comprising:
a motor case;
a gear case disposed adjacent to the motor case; and
a knuckle integrally configured with the gear case.
